(19) United States
(12) Patent Application Publication
(10) Pub. No.: US 2024/0177370 A1
(43) Pub. Date: May 30, 2024

(54) SYSTEMS AND METHODS OF IMAGE TO PALETTE REPRESENTATIONS

(71) Applicant: Perception Systems, LLC, Irvine, CA (US)

(72) Inventors: Mitchell Pudil, Bountiful, UT (US); Michael Blum, Bountiful, UT (US); Jamison Moody, Provo, UT (US); Michael Henry Merchant, Rancho Santa Margarita, CA (US); Danny Petrovich, La Habra Height, CA (US)

(21) Appl. No.: 18/521,123

(22) Filed: Nov. 28, 2023

Related U.S. Application Data
(60) Provisional application No. 63/385,175, filed on Nov. 28, 2022.

(51) Int. Cl. G06T 11/00; G06T 7/90; G06V 10/25

(52) U.S. Cl. CPC G06T 11/001; G06T 7/90; G06V 10/25; G06T 2207/10024; G06T 2207/20084; G06V 2201/07

(57) ABSTRACT

Systems and methods for representing images with palettes are disclosed. The system may include a processor, a memory communicatively coupled to the processor, and an image to palette representation logic. The image to palette representation logic can receive an image, and identify objects in the image. The image to palette representation logic can further determine colors for each identified object, and identify areas of each object that comprise each color. The image to palette representation logic can also calculate areas comprising each color, and generate a palette based on the calculated overall areas. The image to palette representation logic can further calculate a vector associated with the image based on a vector summation of the overall areas and calculate a vector summation for the generated palette. Finally, the image to palette representation logic can store the palette if a closeness ratio associated with the palette is larger than a threshold.

### PRIORITY

This application claims the benefit of and priority to U.S. Provisional Application, entitled “Systems and Methods of Image To Palette Representations,” filed on Nov. 28, 2022 and having application Ser. No. 63/384,175.

### FIELD

The present disclosure relates to image processing systems. More particularly, the present disclosure relates to representing an image by a palette by associating the image with a high-dimensional vector.

### BACKGROUND

Current image recognition techniques often output a class label for an identified object, and image segmentation techniques often create a pixel-level understanding of a scene's elements. Commercial brands and other users are often competing to have an upper hand against their competitors. On one hand, businesses spend heavily to design brands and logos that are appealing to their customers and make them various emotions (such as “feeling good”) about the brand or user. On the other hand, changing color schemes of brands can be expensive, so picking the wrong colors in the brands that are associated with or generate negative responses can cause headaches to the business owners and/or users.

### SUMMARY

Systems and methods for representing an image by a palette by associating the image with a high-dimensional vector in accordance with embodiments of the disclosure are described herein. In many embodiments, a device to represent an image to palette includes a processor, a memory communicatively coupled to the processor, and an image to palette representation logic. The image to palette representation logic can receive an image, identify one or more objects in the image, determine one or more colors for each identified object, identify one or more areas of each identified object that comprise each color of the one or more colors, calculate a set of overall areas comprising each of the one or more colors, and generate a palette based on the calculated set of overall areas.

In some embodiments, the image to palette representation logic can display the generated palette to a user. The image can receive from the user. The image to palette representation logic can further access portions of a color spectrum which include data of colors that are visible to human eye.

The image to palette representation logic can sort the calculated set of overall areas in a descending order. A calculated overall area with a highest value can be sorted at first and a calculated overall area with a lowest value can be sorted at last. In various embodiments, the image to palette representation logic can generate the palette based on a first predefined number of sorted overall areas.

The image to palette representation logic can further generate a vector associated with each of the one or more colors for each of the one or more identified areas. A length of the vector can be indicative of a cross-section of each of the identified one or more areas. Subsequently, the image to palette representation logic can calculate the set of overall areas comprising each of the one or more colors by adding lengths of the vectors associated with the each of the one or more colors.

In an embodiment, the image to palette representation logic can calculate an overall vector associated with the image based on a vector summation of the overall areas, and calculate a vector summation for the generated palette. Further, and in response to a determination that a closeness ratio associated with the generated palette is larger than a pre-determined threshold, the image to palette representation logic can store the palette. The closeness ratio can be defined as an inverse of a difference between the calculated vector summation of the palette and the calculated overall vector associated with the image. The image to palette representation logic can further display the palette to the user. In some embodiments, the user can select the first predefined number of sorted overall areas.

In some embodiments, the image to palette representation logic includes one or more artificial intelligence models, which can include at least one of: a convolutional neural network, a region-based convolutional neural network, and a You Only Look Once neural network. The one or more artificial intelligence models can at least: identify the one or more objects in the image, determine the one or more colors for each identified object, identify the one or more areas of each identified object, calculate the set of overall areas comprising each of the one or more colors, and generate the palette based on the calculated set of overall areas.

Further, the one or more artificial intelligence models can at least: generate the vector associated with each of the one or more colors, calculate the vector summation for the generated palette, and determine whether or not the closeness ratio associated with the generated palette is larger than the pre-determined threshold.

According to another aspect of the present disclosure, a method to represent an image with a palette is disclosed. The method can include receiving an image, identifying one or more objects in the image, determining one or more colors for each identified object, identifying one or more areas of each identified object that comprise each color of the one or more colors, calculating a set of overall areas comprising each of the one or more colors, and generating a palette based on the calculated set of overall areas.

In some embodiments, the method can include sorting the calculated set of overall areas in a descending order. The overall areas are so sorted that a calculated overall area with a highest value is at first and a calculated overall area with a lowest value is at last. The method further includes generating the palette based on a first predefined number of sorted overall areas.

In some embodiments, the method includes generating a vector associated with each of the one or more colors of each of the one or more identified areas. A length of the vector can be indicative of a cross-section of each of the identified one or more areas. The method can include calculating the set of overall areas comprising each of the one or more colors by adding lengths of the vectors associated with the each of the one or more colors.

In some embodiments, the method includes calculating an overall vector associated with the image based on a vector summation of the overall areas and calculating a vector summation for the generated palette. Further, and in response to a determination that a closeness ratio associated with the generated palette is larger than a pre-determined threshold, the method can include storing the palette. The closeness ratio can be defined as an inverse of a difference between the calculated vector summation of the palette and the calculated overall vector associated with the image. In some embodiments, the method includes displaying the generated palette to the user.

In some embodiments, one or more artificial intelligence models can perform at least: identifying the one or more objects in the image, determining the one or more colors for each identified object, identifying the one or more areas of each identified object, calculating the set of overall areas, generating the palette, generating the vector associated with each of the one or more colors, calculating the set of overall areas, calculating the overall vector, calculating the vector summation for the generated palette, and determining whether or not the closeness ratio associated with the generated palette is larger than the pre-determined threshold.

According to yet another aspect of the present disclosure, an image to palette representation system is disclosed. The system can include one or more image to palette representation devices, one or more processors coupled to the one or more image to palette representation devices, and a non-transitory computer-readable storage medium for storing instructions that, when executed by the one or more processors, direct the one or more processors to: receive an image, identify one or more objects in the image, determine one or more colors for each identified object, identify one or more areas of each identified object that comprise each color of the one or more colors, calculate a set of overall areas comprising each of the color for each color, and generate a palette based on the calculated set of overall areas.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a system for representing an image with a palette in accordance with various embodiments of the disclosure;

FIG. 2 is a conceptual diagram of palette generated by system for representing an image with a palette in accordance with various embodiments of the disclosure;

FIG. 3 is a conceptual diagram of a set of adjectives generated by the logic in accordance with various embodiments of the disclosure;

FIG. 4 is a conceptual diagram of a set of palettes generated by the logic in accordance with various embodiments of the disclosure;

FIG. 5 is a conceptual diagram of generating a palette associated with an image in accordance with various embodiments of the disclosure.

FIG. 6 is a flowchart depicting a process for generating a palette for an image in accordance with various embodiments of the disclosure;

FIG. 7 is a flowchart depicting a process for generating a vector summation for an image in accordance with various embodiments of the disclosure;

FIG. 8 is a flowchart depicting a process for generating a palette representing an image in accordance with various embodiments of the disclosure;

FIG. 9 is a conceptual diagram of a device configured to utilize an image to palette representation logic in accordance with various embodiments of the disclosure; and

FIG. 10 is a conceptual network diagram of various environments that an image to palette representation logic may operate within in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the problems described above, systems and methods are discussed herein that can efficiently represent an image with a palette including a plurality of colors. A user can input the image and the system can generate a palette based on the dominant colors of the image. In many embodiments, the system can associate the image with high-dimensional vectors and determine the dominant colors to generate the palette based on vector calculations. In many embodiments, the system can enable the user to select one or more colors which then will be used by the system to generate the palette.

Additionally, in a variety of embodiments, the system can utilize artificial intelligence models to achieve the end goal. That is, the artificial intelligence models can perform some or all of the steps that described herein. Various artificial intelligence models can be used, and the system can train the artificial intelligence models to perform such steps in an efficient manner and with enhanced accuracy.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C. or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an.” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

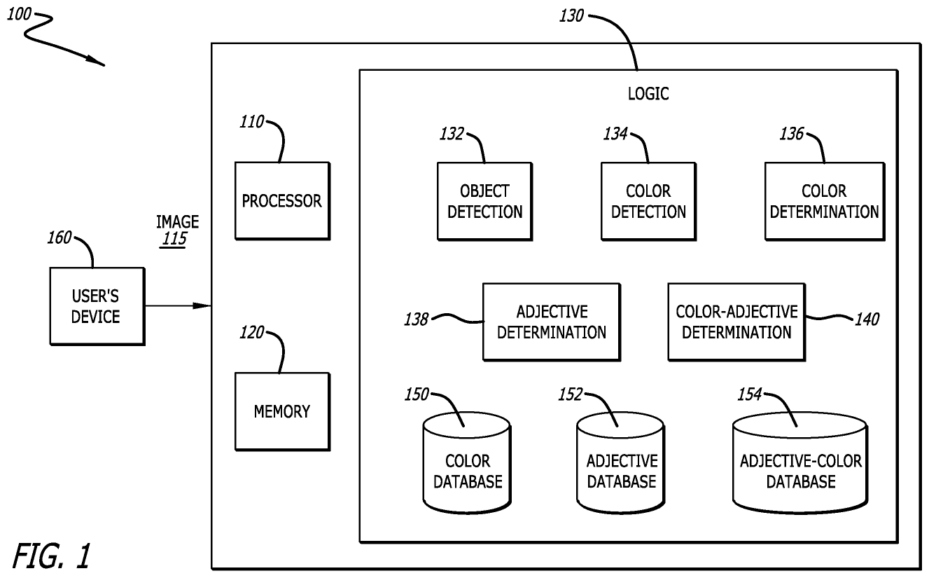

Referring to FIG. 1, a schematic block diagram of a system for representing an image with a palette 100 is shown. The system for representing an image with a palette 100 can include a processor 110, a memory 120 communicatively coupled to the processor 110, and an image to palette representation logic 130. The image to palette representation logic 130 can include an object detection unit 132, a color detection unit 134, a color determination unit 136, an adjective determination unit 138, and a color-adjective determination unit 140. The image to palette representation logic 130 can further include one or more databases including a color database 150, an adjective database 152 and an adjective-color database 154. In many embodiments, the object detection unit 132, the color detection unit 134, the color determination unit 136, the adjective determination unit 138, the color-adjective determination unit 140, the color database 150, the adjective database 152 and the adjective-color database 154 are in communication with each other. Although the image to palette representation logic 130 as illustrated in FIG. 1, includes separate object detection unit 132, color detection unit 134, color determination unit 136, adjective determination unit 138, and color-adjective determination unit 140, in some embodiments, one unit can perform functions of two or more other units. For example, the object detection unit 132 can perform the color detection and object detection tasks, and the adjective determination unit 138 can perform the adjective determination and the color-adjective determination tasks. Similarly, although three separate databases are illustrated in FIG. 1, the image to palette representation logic 130 can include any number of databases. For example, in an embodiment, the image to palette representation logic 130 can include one database including colors, adjectives and adjective-color pairs. In some embodiments, the system for representing an image with a palette 100 can communicate with a user device 160. The user device 160 can be any suitable user device capable of communicating with the image to palette representation logic 130. For example, the user device 160 can be a desktop PC, a laptop, a smartphone, etc. The user device 160 can transmit the image 115 to the system for representing an image with a palette 100. The system for representing an image with a palette 100 can further include a communication interface (not shown). The processor 110 may include one or more central processing units, one or more general-purpose processors, one or more application-specific processors, one or more virtual processors, one or more processor cores, or the like.

In some embodiments, the system for representing an image with a palette 100 can receive an image 115. The image 115 can be transmitted via a user's device 160 in communication with the system for representing an image with a palette 100. As noted above, the user device 160 can be any suitable device capable of communicating with the image to palette representation logic 130.

In various embodiments, the system for representing an image with a palette 100 can utilize one or more artificial intelligence models to perform any of the steps of the operations and steps disclosed herein. The artificial intelligence models can include any of the commercially available artificial intelligence models that are specially trained to perform any of the steps described below. It should be noted that, although not expressly specified, any software, algorithm or model described herein can include a trained artificial intelligence algorithm.

The system for representing an image with a palette 100, or the object detection unit 132 of the image to palette representation logic 130, can identify one or more objects in the image 115. To that end, the system for representing an image with a palette 100 can use an object detection technique to detect the one or more objects in the image. At a high-level, the object detection can be a computer vision technique that allows identifying and locating objects in the image. By utilizing such an identification and localization, the system for representing an image with a palette 100 can further count various objects in the image 115 and determine and track their precise locations, with or without need for labeling them. As a non-limiting example, in case of an image 115 containing two cats and a person, the object detection technique can allow classifying the types of objects found, while also locating instances of such objects within the image 115. While current image recognition techniques may only output a class label for an identified object, and image segmentation techniques may only create a pixel-level understanding of a scene's elements, disclosed object detection technique can benefit from a unique ability to locate objects within the image 115 to count and then track those objects.

The object detection technique can utilize object detection models and deep neural networks. The object detection models can be trained to detect the presence of specific objects. Although disclosed models are used in images, it should be noted that disclosed models can also be used in videos, and/or real-time operations.

In some embodiments, the system for representing an image with a palette 100 may detect objects in the image 115 without utilizing deep neural network. For example the system for representing an image with a palette 100 can use a histogram of oriented gradients to detect objects. That is, for a particular pixel in the image 115, the histogram of the gradient can be calculated by considering the vertical and horizontal values to obtain feature vectors. Utilizing the gradient magnitude and the gradient angles, the system for representing an image with a palette 100 can get a clear value for the current pixel by exploring the other entities in their horizontal and vertical surroundings. The system for representing an image with a palette 100 can consider an image segment of a particular size. The first step is to find the gradient by dividing the entire computation of the image 115 into gradient representations of cells, e.g., 8×8 cells. In such an embodiment, with the help of the 64 gradient vectors that are achieved, the system for representing an image with a palette 100 can split each cell into angular bins and compute the histogram for the particular area. This process reduces the size of 64 vectors to a smaller size of 9 values. Once the system for representing an image with a palette 100 obtains the size of 9 point histogram values for each cell, the system for representing an image with a palette 100 can then choose to create overlaps for the blocks of cells. The final steps may be forming the feature blocks, normalizing the obtained feature vectors, and collecting all the features vectors to get an overall histogram of oriented gradients feature.

According to some embodiments, the object detection technique may make use of special and unique properties of each class to identify the required object. For example, while looking for square shapes, the object detection technique can look for perpendicular corners that will result in the shape of a square, with each side having the same length. As another example, while looking for a circular object, the object detection technique may look for central points from which the creation of the particular round entity is possible.

According to another embodiment, the system for representing an image with a palette 100 may extract the most essential features (e.g., 2000 features) by making use of selective features. In some embodiments, the process of selecting the most significant extractions can be computed with the help of a trained selective search algorithm that can achieve these more important regional proposals. To that end, the selective search algorithm of the image to palette representation logic 130 can generate multiple sub-segmentations on the image 115. The selective search algorithm of the system for representing an image with a palette 100 can then use a recurring process to combine the smaller segments into suitable larger segments. Subsequently, the system for representing an image with a palette 100 may extract the features and make the appropriate predictions. The system for representing an image with a palette 100 can create an n-dimensional (e.g., 2048, 4096, etc.) feature vector as output based on final candidate. The final step can include making the appropriate predictions for the image 115 and label the respective bounding box accordingly. In order to obtain the best results for each task, the predictions can be made by the computation of a classification model for each task, while a regression model is used to correct the bounding box classification for the proposed regions.

In some embodiments, the system for representing an image with a palette 100 may use fixed size sliding windows, which slide from one side to another side (e.g., left-to-right and top-to-bottom) to locate objects at different locations. Then, the system for representing an image with a palette 100 may proceed with forming an image pyramid to detect objects at varying scales, and performing a classification via a trained classifier. In such embodiments, at each stop of the sliding window and image pyramid, the system for representing an image with a palette 100 may extract the region of interest, and feed it into a neural network to obtain the output classification for the region of interest. If the classification probability of label (L) is higher than a certain threshold, the system for representing an image with a palette 100 can mark the bounding box of the region of interest as the label (L). Repeating this process for every stop of the sliding window and image pyramid, the system for representing an image with a palette 100 can obtain the output object detectors. Finally, the system for representing an image with a palette 100 can apply non-maxima suppression to the bounding boxes yielding the final output detections.

In some embodiments, an artificial intelligent-based approach can be used to look at various features of the image, such as the color histogram or edges, to identify groups of pixels that may belong to an object. The system for representing an image with a palette 100 can feed such features into a regression model that predicts the location of the object along with its label. In some embodiments, the system for representing an image with a palette 100 may utilize a deep learning-based approaches that employs convolutional neural networks to perform end-to-end, unsupervised object detection, in which features may not need to be defined and extracted separately. In certain embodiments, the neural network may be configured as a convolutional neural network, a region-based convolutional neural network, and/or a You Only Look Once neural network

In some embodiments, the system for representing an image with a palette 100, or the color detection unit 134 of the image to palette representation logic 130, can determine one or more colors for each of the identified objects. In some embodiments, the determination of the one or more colors can include detecting a list of the most important colors within the detected objects of the image. Such most important colors can include 3 types of colors: the dominant color, the accent colors, and the secondary colors. The dominant colors may be the colors that would be perceived as being the dominant one in the image by a human viewer and can take into account at least one of: the area covered by (i.e., comprised of) the color, the way this area is distributed in the image, and the intensity of the color as perceived by humans. For instance, highly saturated colors, or colors close to red/yellow/orange will stand out more than duller colors, which can be accounted for in the color detection.

Alternatively, the system for representing an image with a palette 100 may detect accent color. Accent colors are colors that are not dominant in the image, that sometimes may occupy a small area of the image, but that still draw the human eye's due to their intensity, contrast or saturation. For example, in an image of a person wearing a red T-shirt, the red T-shirt, although small in area, may have an impactful color. In such a scenario, the system for representing an image with a palette 100 may detect the red T-shirt as an accent color.

Finally, the system for representing an image with a palette 100 can detect secondary colors. Secondary colors are colors that are important in the image but that are neither the dominant one nor accent colors. In various embodiments, the user can choose the secondary colors. Alternatively, the system for representing an image with a palette 100 may determine that a specific color, which is neither a dominant nor an accent color, is important (e.g., an important object of the image comprises the color) and mark the color as one of the most important colors used to generate the palette representing the image 115.

In various embodiments, the system for representing an image with a palette 100 can perform edge detection. The system for representing an image with a palette 100 may repeat the edge detection multiple times. In an embodiment, the system for representing an image with a palette 100 can perform the edge detection three times: at least once for red, at least one for green, and at least once for blue. The system for representing an image with a palette 100 can further perform the edge detection for any other color space. The system for representing an image with a palette 100 then can fuse the output to form one edge map. Alternatively, the system for representing an image with a palette 100 can use a multi-dimensional gradient method to detect colors. The multi-dimensional gradient can be a short-circuit the process which combines the three gradients into one and detect edges only once.

According to some embodiments of the present disclosure, in order to detect the colors, the system for representing an image with a palette 100, or the color determination unit 136 of the image to palette representation logic 130, can access a database of color data. The color data can include the data that is required to detect each color. For example, the database can include a color spectrum. The color spectrum can include at least color data that is visible to human eye. However, it should be noted, the color spectrum can include color data that is not visible to human eye. As a non-limiting example, the color spectrum may include color data attributed to infra-red portion of the color spectrum and/or ultra-violet portion of the color spectrum. The database of color data can be stored in the system for representing an image with a palette 100. Alternatively, the system for representing an image with a palette 100 can access a remote database of color data which is located outside the system for representing an image with a palette 100.

In some embodiments, the system for representing an image with a palette 100 can identify one or more areas of each identified object that comprise each identified color. The system for representing an image with a palette 100 can determine boundaries of each object. By employing boundary detection, the system for representing an image with a palette 100 can find the semantic boundaries between what humans would consider to be different objects or regions of the image. For example, a zebra has many internal edges between black and white stripes, but humans wouldn't consider those edges part of the boundary of the zebra. Such a boundary detection can include running an edge detection algorithm on the image. To improve the chance that an edge detection algorithm of the system for representing an image with a palette 100 will find an actual semantic boundary, the edge detector algorithm may be an average of multiple edge detector algorithms at different resolutions. In an embodiment, the average edge detector algorithm approach may give lower weight to edges that only appear at finer resolutions.

The boundary probability estimate can combine a texture gradient and a brightness gradient. Texture can be measured by assigning a per-pixel texton identifier, where areas of the image that have similar texture will have similar distributions of texton identifiers. The system for representing an image with a palette 100 can compute the texton identifiers by first creating a per-pixel vector where each element is the image convolved with a different filter, then clustering those vectors using k-means (i.e., with k=64). That is, textons can be unique to the image they originated from. In some embodiments, the system for representing an image with a palette 100 can use filters, e.g., gaussian filters.

The system for representing an image with a palette 100 can compute the rate of change in the local distribution of textons. The local distribution of textons is the sum of many directional gradients over several scales and orientations, all computed in circular neighborhoods. Each directional gradient divides the circular neighborhood into two half-disks and may further use chi-squared distance to compare the texton distributions under each half-disk. The chi-squared distance computation can be optimized using any suitable commercial software, such as MATLAB™ The system for representing an image with a palette 100 can further use the same brightness gradient computation as the texture gradient computation.

In some embodiments, the system for representing an image with a palette 100 can calculate a set of overall areas comprising each of the identified colors. Once the boundaries of each object are determined, the system for representing an image with a palette 100 can calculate the area under the curve utilizing any suitable method. The system for representing an image with a palette 100 may add cross-sections of areas which are covered by (i.e., comprised of) the same color to calculate an overall cross section of area covered by the color. In general, the area covered by a color can be the total number of pixels that include the same color.

Alternatively, in some embodiments, the system for representing an image with a palette 100 can generate a vector associated with each area comprising a color. The system for representing an image with a palette 100 can generate each vector in such a way that a length of the vector is proportional to the cross section of the area that comprises the color. The system for representing an image with a palette 100 can further add the lengths of each vector that is associated with each color, hence, calculating the total cross section of areas that includes each color.

In some embodiments, the system for representing an image with a palette 100 can generate a palette based on the calculated set of overall areas. Additionally, or in the alternative, in some embodiments, the system for representing an image with a palette 100 can generate the palette based on the calculated set of overall vectors.

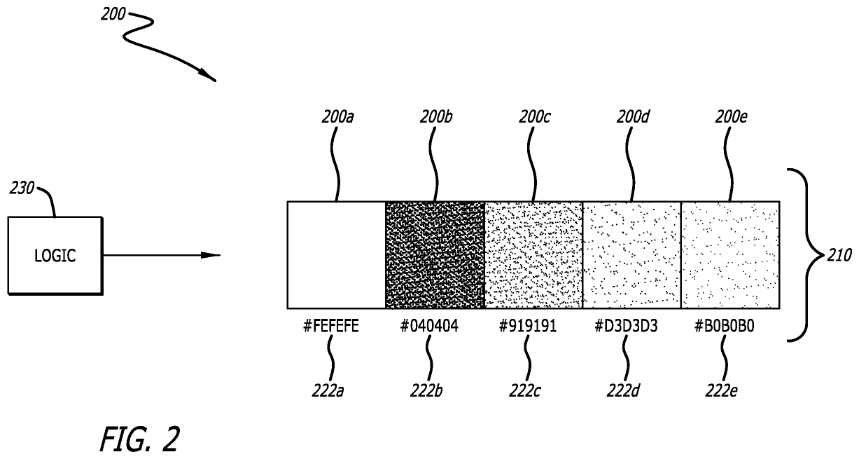

Although a specific embodiment for a schematic block diagram of a system for representing an image with a palette suitable for carrying out the various steps, processes, methods, and operations described herein is discussed with respect to FIG. 1, any of a variety of systems and/or processes may be utilized in accordance with embodiments of the disclosure. For example, the image to palette representation logic may be implemented across a variety of the systems described herein such that some representations are generated on a first system type (e.g., remotely), while additional steps or actions are generated or determined in a second system type (e.g., locally). The elements depicted in FIG. 1 may also be interchangeable with other elements of FIGS. 2-10 as required to realize a particularly desired embodiment.

Referring to FIG. 2 now, a conceptual diagram 200 of palette 210 generated by the image to palette representation logic 230 is shown, according to some embodiments. As noted above, the image to palette representation logic 230 can generate the palette based on the calculated set of overall areas or the calculated set of overall vectors. The palette can include a set of colors 220a, 220b, 220c. 220d and 220e. While the palettes 210 shown in FIG. 2 includes 5 colors, it should be noted that the palette can include any number of colors. The palette 210 can further include metadata associated with each color. For example, the palette 210 can include identifying color codes 222a, 222b, 222c. 222d and 222e associated with each color 220a, 220b, 220c. 220d and 220c, as shown in FIG. 2.

Each vector may be represented as a combination of direction and magnitude. In various embodiments, in order to calculate the sum of two vectors, the system for representing an image with a palette 210 can place the vectors so the first end of both vectors, i.e., the origins of vectors, are located at a common point. The system for representing an image with a palette 210 then can add the vectors based on conventional vector summation formula, e.g., parallelogram law, to calculate each of the set of overall vectors. The system for representing an image with a palette 210 can further sort the set of overall vectors based on their respective length. In other words, by combining the cross sections of the areas that comprise each color, the system for representing an image with a palette 210 is able to determine the dominant color(s), accent color(s) and secondary color(s) by sorting the summations of lengths of vectors associated with each color. Thus, for example, when color A is the dominant color in the image, and color B is the secondary color, then the vector associated with the color A has a higher length than the vector associated with the color B.

In some embodiments, the system for representing an image with a palette 210 can display a pre-defined number of colors to the user based on the lengths of the vectors associated with the colors. The user may be able to determine the pre-defined number prior to displaying the colors. Additionally, the system for representing an image with a palette 210 can select the pre-defined number of colors and generate a palette including the pre-defined number of colors. Subsequently, the system for representing an image with a palette 210 can display the palette to the user.

The system for representing an image with a palette 210 may generate more than one palette. As a non-limiting example, the image may include multiple dominant colors. In such instances, the pre-defined number of colors that is included in the generated palette may be insufficient to show every dominant color. As another non-limiting example, the image may include several colors, with no dominant colors. In yet another non-limiting example, the user may request additional colors to be shown and/or suggested in the palette. In such instances, the palette may not be able to display all the dominant colors, each of the several colors, or the requested colors, respectively. Thus, additional palettes may be needed to be generated. In response to such instances, the system for representing an image with a palette 210 can generate additional palettes. Each additional palette should satisfy a condition which is how close the vectors associated with such additional palette and the image are. Therefore, the system for representing an image with a palette 210 can generate the additional palette based on a closeness ratio between the overall vector associated with the additional palette and the overall vector associated with the image.

To that end, the system can define the closeness ratio based on a suitable mathematical formula. In some embodiments, the closeness ratio is defined as an inverse of a difference between the overall vector associated with the palette and the vector associated with the image. The system for representing an image with a palette 210 can then identify a set of colors that may be possible candidates to form the additional palette (e.g., colors selected by the user, dominant color not included in the first generated palette, etc.). The system for representing an image with a palette 100 then calculates the overall vector associated with the possible additional palette. The system for representing an image with palette 210 can calculate the inverse of the difference between the vector associated with the image and the vector associated with the possible additional palette, i.e., the closeness ratio. If the closeness ratio exceeds a certain threshold, then the system for representing an image with a palette 210 can store the possible additional palette as an additional palette. Otherwise, if the closeness ratio does not exceed the threshold, then the system for representing an image with a palette 210 can discard the possible additional palette. In various embodiments, the threshold can be determined by the user or the system for representing an image with a palette 210. For example, the threshold can be defined as a percentage (e.g., above 80%). In some embodiments, in response to a determination that none of the possible additional palettes satisfies the requirement (i.e., none of the possible additional palettes has a closeness ratio that exceeds the threshold), the system for representing an image with a palette 210 can increase the threshold or request the user to increase the threshold. Additionally, in some embodiments, in response to a determination that multiple possible additional palettes satisfy the requirement (i.e., multiple possible additional palettes have closeness ratios that exceed the threshold), the system for representing an image with a palette 210 can decrease the threshold or request the user to decrease the threshold. The system for representing an image with a palette 210 can further sort the additional palettes based on their respective closeness ratios and display a pre-defined number of additional palettes to the user with the highest closeness ratio. As those skilled in the art will recognize, the displaying may occur on a graphical user interface, such as on a computing device, etc.

Although a specific embodiment for a conceptual diagram of palette generated by system for representing an image with a palette suitable for carrying out the various steps, processes, methods, and operations described herein is discussed with respect to FIG. 2, any of a variety of systems and/or processes may be utilized in accordance with embodiments of the disclosure. For example, image codes may be hexadecimal, but may be any identification data that can be equated with a specific shade/color. The elements depicted in FIG. 2 may also be interchangeable with other elements of FIGS. 1 and 3-10 as required to realize a particularly desired embodiment.

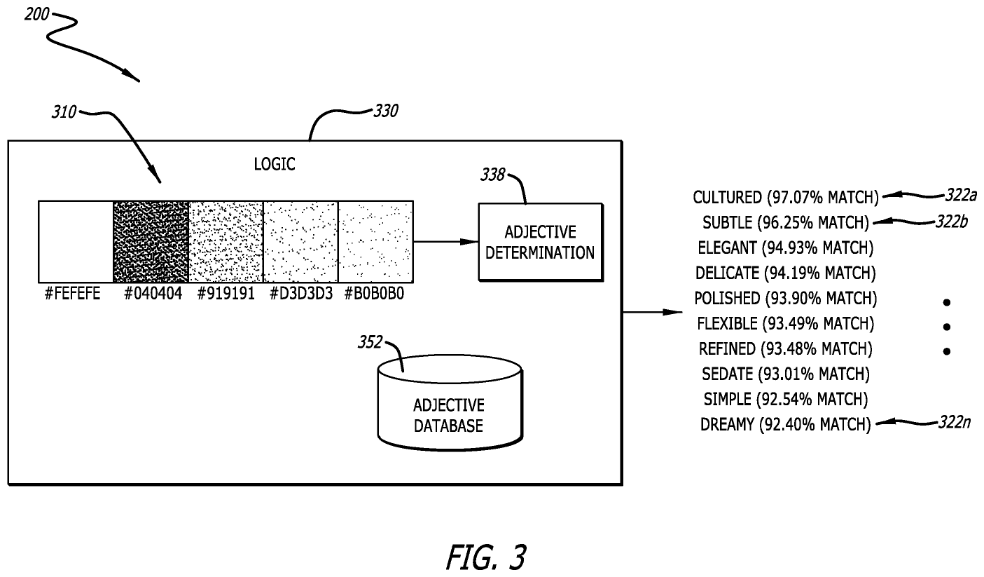

Referring to FIG. 3, a conceptual diagram of a set of adjectives generated by the logic 330 is shown, according to some embodiments. In some embodiments, the system 300 can generate a set of adjectives 320 based on the image. To that end, the adjective determination unit 338 of the logic 330 can access the adjective database 352 to determine the set of adjectives 320 associated with the image. In some embodiments, the logic 330 can determine the palette 310, which is followed by determination of the set of adjective 320. Each adjective can be pre-classified with one or more colors in the adjective database 352. Alternatively, the system 300 can generate a vector associated with each adjective and store the adjective along with its associated vector in the adjective database 352. The system 300 can then compare the vectors associated with each adjective and the vector associated with the palette in order to determine the set of adjectives representing the palette 310. The system 300 can use a closeness ratio to determine the set of generated adjectives 320. Each adjective of the set of adjectives 320 can include an adjective and the corresponding closeness ratio 322a, 322b, . . . 322n. In some embodiments, the user selects the number of adjectives. Additionally, in some embodiments, the user selects the closeness ratio and/or the threshold.

Although a conceptual diagram of a set of adjectives generated by the logic suitable for carrying out the various steps, processes, methods, and operations described herein is discussed with respect to FIG. 3, any of a variety of systems and/or processes may be utilized in accordance with embodiments of the disclosure. For example, adjectives may be in English, but may be in other languages or a numerical code that can be equated with a specific word. The elements depicted in FIG. 3 may also be interchangeable with other elements of FIGS. 1-2 and 4-10 as required to realize a particularly desired embodiment.

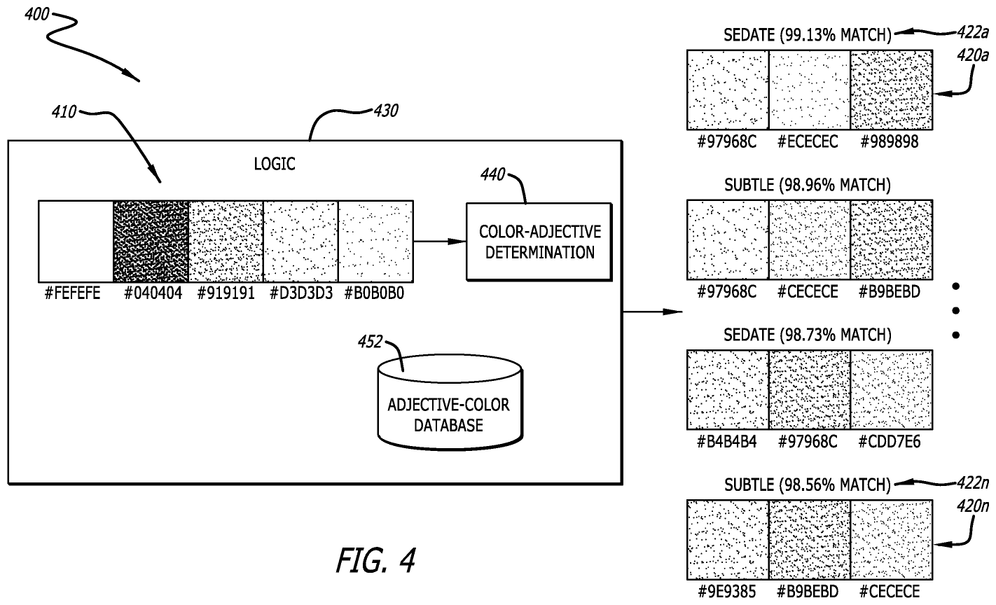

Referring to FIG. 4 now, a conceptual diagram of a set of palettes generated by the logic 400 is shown, according to some embodiments. In some embodiments, the image to palette representation logic 430 can generate more than one palettes based on the calculated set of overall areas or the calculated set of overall vectors. Each of the palettes 420a, . . . , 420n can include a set of colors, similar to the set of colors of the palette as shown in FIG. 2. It is worth noting that, while the set palettes 420a, . . . , 420n shown in FIG. 4 include 3 colors, the palettes can include any number of colors. The palettes 420a, . . . , 420n can further include the closeness ratio associated with each color 422a, . . . , 422n. The user may select the number of colors in each palette. Additionally, the user may select the closeness ratio and the threshold.

In some embodiments, a machine learning model may be utilized to determine colors within a set of palettes based on human perception. In some embodiments, this can be utilized to analyze websites as well as images. In additional embodiments, the training of the machine learning model can be based on a survey given to people that indicate prominent colors. For example, in a particular image or other analyzed color scheme, a small patch of blue color on a white background would be prioritized in a palette as it stands out in general human perception, wherein other methods would ignore the blue color as doesn't have a large amount of pixels or associated area compared to the white background. In still further embodiments, the machine learning model can be trained on photos uploaded to one or more photo sharing sites. In more embodiments, the selection of colors can be normalized or otherwise adjusted based on various culture or demographic data.

Although a conceptual diagram of a set of adjectives generated by the logic suitable for carrying out the various steps, processes, methods, and operations described herein is discussed with respect to FIG. 4, any of a variety of systems and/or processes may be utilized in accordance with embodiments of the disclosure. For example, multiple palettes may be associated with a single adjective or multiple adjectives depending on the culture or other application. The elements depicted in FIG. 4 may also be interchangeable with other elements of FIGS. 1-3 and 5-10 as required to realize a particularly desired embodiment.

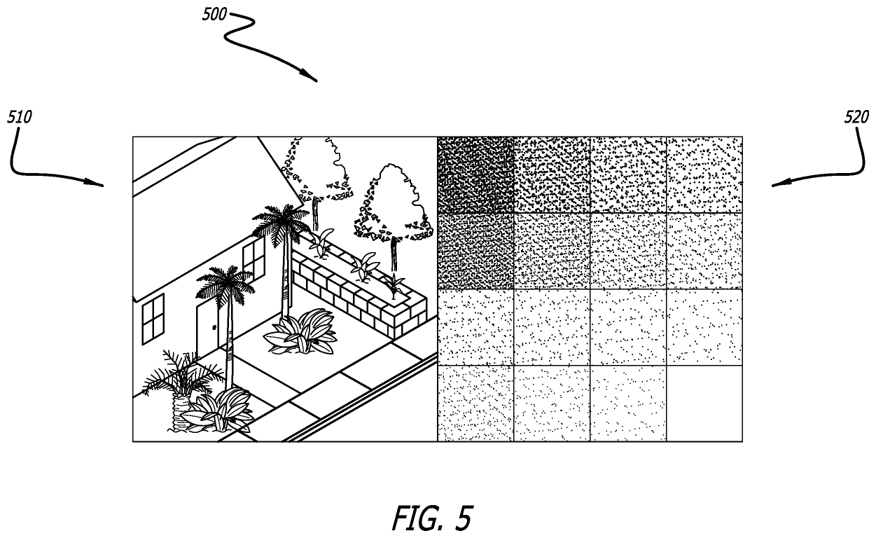

Referring to FIG. 5, a conceptual diagram of generating a palette associated with an image 500 is shown, in accordance with an embodiment. In some embodiments, the image 510, which can be received from the user, is transformed into a pixel representation 520 in order to generate the vectors associated with each color of the identified object in the image. In a non-limiting example, in an image which includes a house with a yard, the palette can be generated based on detecting objects such as the house, the yard, and a few trees. The palette can include the dominant colors of the objects. For example, as the trees may share a common color, their dominant color can be one of the colors used in the palette. Further, the palette can include the dominant color(s) of the interior of the house and the dominant color(s) of the yard.

Although a conceptual diagram of a set of adjectives generated by the logic suitable for carrying out the various steps, processes, methods, and operations described herein is discussed with respect to FIG. 5, any of a variety of systems and/or processes may be utilized in accordance with embodiments of the disclosure. For example, a palette may be generated based on a confluence of multiple images. The elements depicted in FIG. 5 may also be interchangeable with other elements of FIGS. 1-4 and 6-10 as required to realize a particularly desired embodiment.

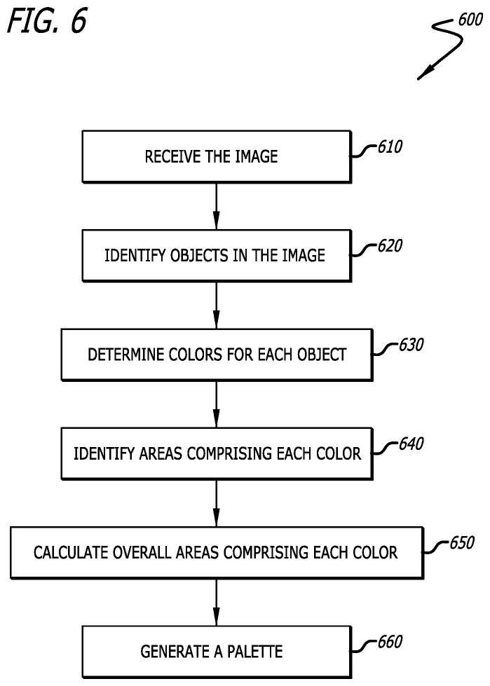

Referring to FIG. 6, a flowchart depicting a process 600 for generating a palette for an image in accordance with an embodiment of the disclosure is shown. In many embodiments, the process 600 can first receive the image, as shown in block 610. The image can be transmitted via a user's device in communication with the system for representing an image with a palette.

The process 600 can identify objects in the image, as shown in block 620. An object detection technique can be used to detect the one or more objects in the image. Various objects in the image can be counted and located, with or without need for labeling them. The object detection technique can include object detection models and deep neural networks. The models can be trained to detect the presence of specific objects. The process 600 may extract features from the image by using specially trained models.

In some embodiments the process 600 can determine colors for each object, as shown in block 630. The determination of the colors can include detecting a list of the most important colors within the detected objects of the image by performing edge detection. Alternatively, the process 600 may access a database of color data including the data that is required to detect each color.

In many embodiments, the process 600 can proceed to identify areas comprising each color, as shown in block 640. In some embodiments, the process 600 can determine boundaries of each object and find the boundaries between what humans would consider to be different objects or regions of the image. Such a boundary detection can include running an edge detection algorithm on the image and using an average of multiple edge detector algorithms at different resolutions.

In additional embodiments, the process 600 can calculate overall areas comprising each color, as shown in block 650. Once the boundaries of each object are determined, the process 600 can calculate the area under the curve utilizing any suitable method. Alternatively, the process 600 can generate a vector associated with each area comprising a color in such a way that a length of each vector is proportional to the cross section of the area that comprises the color. The process 600 can further add the lengths of each vector that is associated with each color, hence, calculate the total cross section of areas that includes each color. In an embodiment, the process 600 can generate a palette, as shown in block 660. In some embodiments, the process 600 can generate the palette based on the calculated set of overall areas or the calculated set of overall vectors. In more embodiments, the calculated set can be sorted in descending order with a highest value at first and a lowest value at the last.

Although a conceptual diagram of a set of adjectives generated by the logic suitable for carrying out the various steps, processes, methods, and operations described herein is discussed with respect to FIG. 6, any of a variety of systems and/or processes may be utilized in accordance with embodiments of the disclosure. For example, the objects in the image may be detected via a machine learning process but may be executed by a remote or cloud-based service. The elements depicted in FIG. 6 may also be interchangeable with other elements of FIGS. 1-5 and 7-10 as required to realize a particularly desired embodiment.

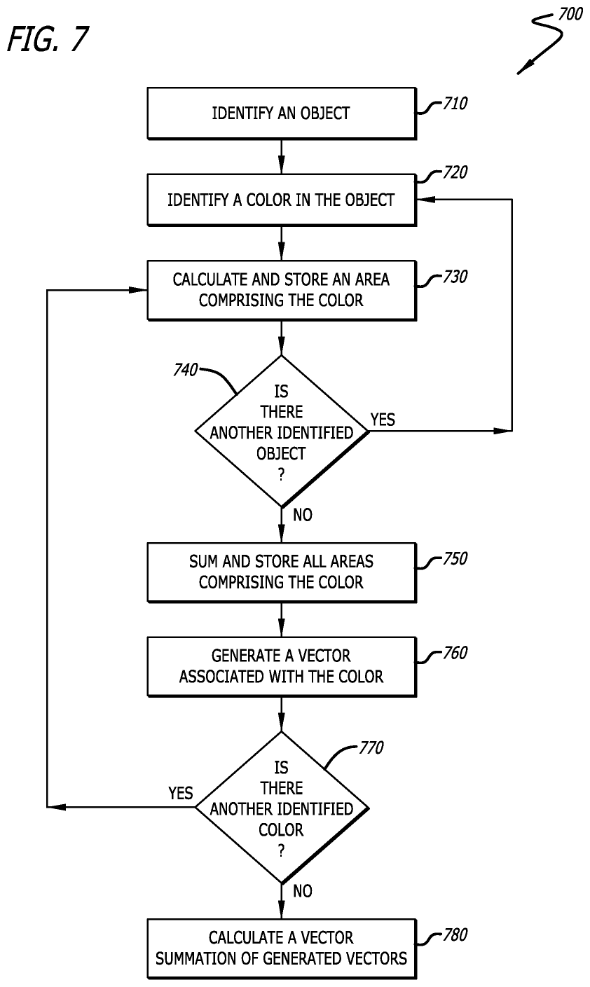

Referring to FIG. 7, a flowchart depicting a process 700 for generating a vector summation for an image in accordance with an embodiment of the disclosure is shown. In many embodiments, the process 700 can first identify an object, as shown in block 710. The process 700 can identify the objects in a manner similar to object identification block 620 as described in FIG. 6. Next, the process 700 can identify a color in the object, as shown in block 720. The process 700 can identify the color in a manner similar to color identification block 630 as described in FIG. 6.

The process 700 can proceed to calculate and store an area comprising the color. The process 700 can identify boundaries of each object and then calculate the area under the curve. The process 700 can further add each calculated area.

The process 700 can subsequently determine whether any additional object is identified in the image, as shown in block 740. If there are additional objects identified in the image, then the process 700 can move to the next object and the process 700 can start over from the first block 720. Once there is no additional identified object in the image, the process 700 can proceed to block 750, where the process 700 can sum and store areas comprising the colors.

In some embodiments, the process 700 can generate a vector associated with the color, as shown in block 760. The process 700 can generate the vector associated to each area including a color in such a way that a length of the vector is proportional to the cross section of the area that includes the color. The process 700 can determine whether there is any other identified color in the image, as shown in block 770. If there are additional colors, then the process 700 can move to next color and start over from step 730. Otherwise, if there is no additional color, the process 700 can proceed to block 780, to calculate a vector summation of the generated vectors. The process 700 can be set up for adding the lengths of each vector that is associated with each color to the total cross section of areas that includes each color. In various embodiments, in order to calculate the sum of two vectors, the process 700 can place the vectors so the origins of vectors are located at a common point. The process 700 then can add the vectors based on conventional vector summation formula, e.g., parallelogram law.

Although a conceptual diagram of a set of adjectives generated by the logic suitable for carrying out the various steps, processes, methods, and operations described herein is discussed with respect to FIG. 7, any of a variety of systems and/or processes may be utilized in accordance with embodiments of the disclosure. For example, other data associated with an image may be analyzed, including depth data, infrared data, or the like. The elements depicted in FIG. 7 may also be interchangeable with other elements of FIGS. 1-6 and 8-10 as required to realize a particularly desired embodiment.

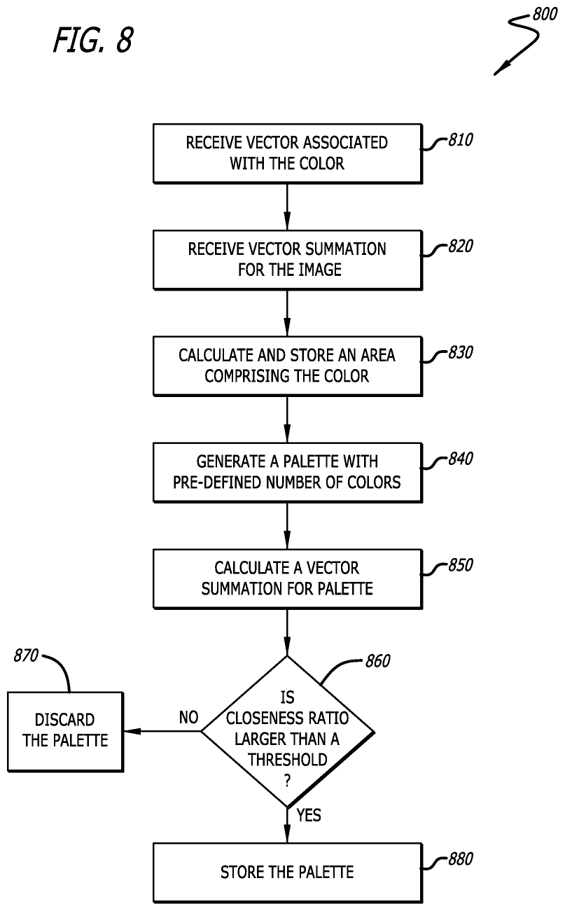

Referring to FIG. 8, a flowchart depicting a process 800 for generating a palette representing an image in accordance with an embodiment of the disclosure is shown. In many embodiments, the process 800 can first receive vector associated with color, as shown in block 810. In many embodiments, the process 800 can receive the vector associated with the color which is generated in block 760 of FIG. 7. In additional embodiments, the process 800 can receive the vector summation associated with image, as shown in block 820. In some embodiments, the process 800 can receive the vector summation associated with the image which is generated in block 780 of FIG. 7.

Next, the process 800 can calculate and store an area comprising the color, as shown in block 830. In some embodiments, the operation to calculate the area comprising the color can be similar to the operation performed in block 750 of FIG. 7. The process 800 can proceed to generate a palette with pre-defined number of colors, as shown in block 840. The operation to generate the palette can be similar to the operation performed in block 660 of FIG. 6. In some embodiments, the generation can be based on a first predefined number of sorted overall areas.

In additional embodiments, the process 800 can calculate a vector summation for the palette, as shown in block 850. The operation to calculate the vector summation can be similar to the operation performed in other steps to calculate vector summation. As a result of the steps 810-850 of the process 800, the process 800 can generate a set of palettes.

In some embodiments, the process 800 can proceed to determine whether each of the generated palettes satisfies a condition, as shown in block 860. The condition can be satisfied once a calculated closeness ratio exceeds a certain predetermined threshold. To that end, the process 800 can define the closeness ratio based on a mathematical formula. In some embodiments, the closeness ratio can be defined as an inverse of a difference between the overall vector associated with the palette and the vector associated with the image. The process 800 can calculate the inverse of the difference between the vector associated with the image and the vector associated with each palette, i.e., the closeness ratio. If the closeness ratio exceeds the threshold, then the process 800 stores the palette. Otherwise, if the closeness ratio does not exceed the threshold, then the process 800 discards the palette. In various embodiments, the threshold can be determined by the user. In some embodiments, in response to a determination that none of the palettes satisfies the requirement (i.e., none of the palettes has a closeness ratio that exceeds the threshold), the process 800 can increase the threshold or request the user to increase the threshold. Additionally, in some embodiments, in response to a determination that multiple palettes satisfy the requirement (i.e., multiple palettes have closeness ratios that exceed the threshold), the process 800 can decrease the threshold or request the user to decrease the threshold. The process 800 can further sort the palettes based on their respective closeness ratios and display a pre-defined number of additional palettes to the user with the highest closeness ratio.

Although a conceptual diagram of a set of adjectives generated by the logic suitable for carrying out the various steps, processes, methods, and operations described herein is discussed with respect to FIG. 8, any of a variety of systems and/or processes may be utilized in accordance with embodiments of the disclosure. For example, multiple palettes may be associated with a single adjective or multiple adjectives depending on the culture or other application. The elements depicted in FIG. 8 may also be interchangeable with other elements of FIGS. 1-7 and 9-10 as required to realize a particularly desired embodiment.

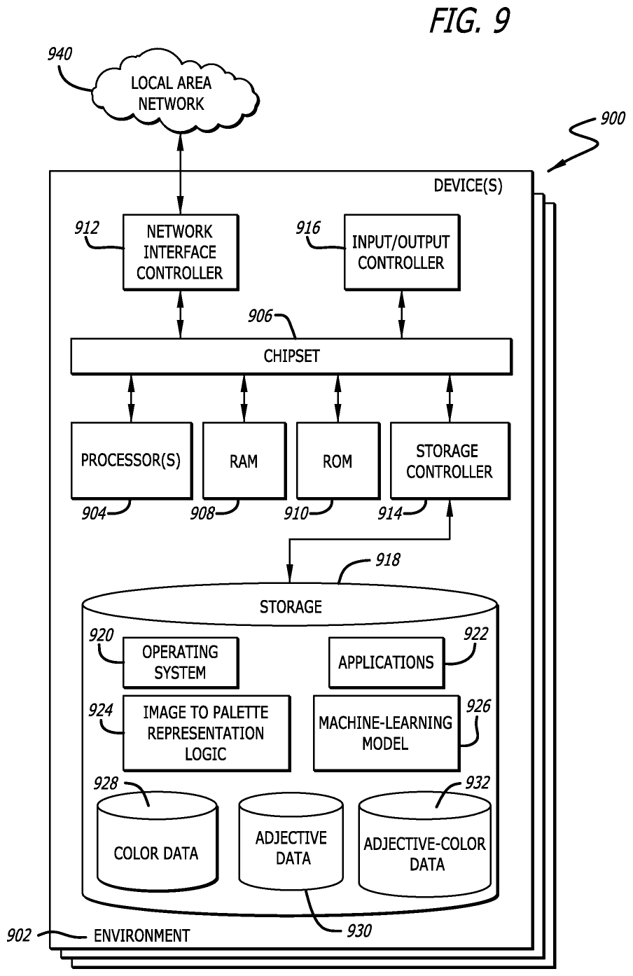

Referring to FIG. 9, a conceptual block diagram of a device suitable for configuration with a movement detection logic in accordance with various embodiments of the disclosure is shown. The embodiment of the conceptual block diagram depicted in FIG. 9 can illustrate a conventional server computer, workstation, desktop computer, laptop, tablet, network device, access point, router, switch, e-reader, smart phone, centralized management service, or other computing device, and can be utilized to execute any of the application and/or logic components presented herein. The device 900 may, in some examples, correspond to physical devices and/or to virtual resources and embodiments described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In additional embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 906 may provide an interface between the processor(s) 904 and the remainder of the components and devices within the environment 902. The chipset 906 can provide an interface to communicatively couple a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Different embodiments of the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for example, store an operating system 920, applications 922, and data 928, 930, 932, which are described in greater detail below. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

For example, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In various embodiment, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as application 922 and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-9. In more embodiments, the device 900 can also include computer-readable storage media having instructions stored thereupon for performing any of the other computer-implemented operations described herein.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9 and can include other components that are not explicitly shown in FIG. 9 or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

In many embodiments, the device 900 can include an image to palette representation logic 924 that can be configured to perform one or more of the various steps, processes, operations, and/or other methods that are described above. While the embodiment shown in FIG. 9 depicts a logic focused on network capacity, it is contemplated that a more general “network needs” logic may be utilized as well or in lieu of such logic. Often, the image to palette representation logic 924 can be a set of instructions stored within a non-volatile memory that, when executed by the controller(s)/processor(s) 904 can carry out these steps, etc. In some embodiments, the image to palette representation logic 924 may be a client application that resides on a network-connected device, such as, but not limited to, a server, switch, personal or mobile computing device in a single or distributed arrangement. In certain embodiments, the image to palette representation logic 924 can be a dedicated hardware device or be configured into a system on a chip package (FPGA, ASIC and the like).

In a number of embodiments, the storage 918 can include color data 928. As discussed above, the color data 928 can be collected in a variety of ways and may involve data related to multiple images. The color data 928 may be associated with an entire image or a portion/partition of an image. This may also include a relationship of the various associated images that are associated with each other. In additional embodiments, the color data 928 can include not only color-related data, but may also include details about the metadata, color-coding, device hardware configuration and/or capabilities of the devices within the image processing pipeline. This can allow for more reliable adjective and/or palette determinations.

In various embodiments, the storage 918 can include adjective data 930. As described above, adjective data 930 can be configured to include various adjectives, as well as previously determined adjective associations. The adjective data 930 may be formatted to store a range of values for each type of adjective. These adjectives can be utilized to compare against current values or images. This adjective data 930 can be provided by a provider prior to deployment. However, system administrators may train or otherwise associate these values by utilizing feedback on correct and incorrect detected relationships.

In still more embodiments, the storage 918 can include adjective-color data 932. As discussed above, adjective-color data 932 can be utilized to verify the relationship between an adjective and a color. Likewise, by utilizing adjective-color data 932, the type of associations may be better discerned. Likewise, one or more palettes may be generated by utilizing the adjective-color data 932.

Finally, in many embodiments, data may be processed into a format usable by a machine-learning model 926 (e.g., feature vectors, etc.), and or other pre-processing techniques. The machine learning (“ML”) model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models 926. The ML model 926 may be configured to learn the pattern of historical movement data of various network devices and generate predictions and/or confidence levels regarding current anomalous movements. In some embodiments, the ML model 926 can be configured to determine various adjective and color relationships to generate a palette related to an image as well as parsing out various object and/or portions of the images.

The ML model(s) 926 can be configured to generate inferences to make predictions or draw conclusions from data. An inference can be considered the output of a process of applying a model to new data. This can occur by learning from at least the topology data, historical data, measurement data, profile data, neighboring device data, and/or the underlying algorithmic data and use that learning to predict future outcomes and needs. These predictions are based on patterns and relationships discovered within the data. To generate an inference, such as a determination on anomalous movement, the trained model can take input data and produce a prediction or a decision/determination. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes. The training set of the ML model(s) 926 can be provided by the manufacturer prior to deployment and can be based on previously verified data.

Although a specific embodiment for a device suitable for configuration with a network capacity prediction logic suitable for carrying out the various steps, processes, methods, and operations described herein is discussed with respect to FIG. 9, any of a variety of systems and/or processes may be utilized in accordance with embodiments of the disclosure. For example, the device may be in a virtual environment such as a cloud-based network administration suite, or it may be distributed across a variety of network devices or APs such that each acts as a device and the image to palette representation logic 924 acts in tandem between the devices. The elements depicted in FIG. 9 may also be interchangeable with other elements of FIGS. 1-9 and 10 as required to realize a particularly desired embodiment.

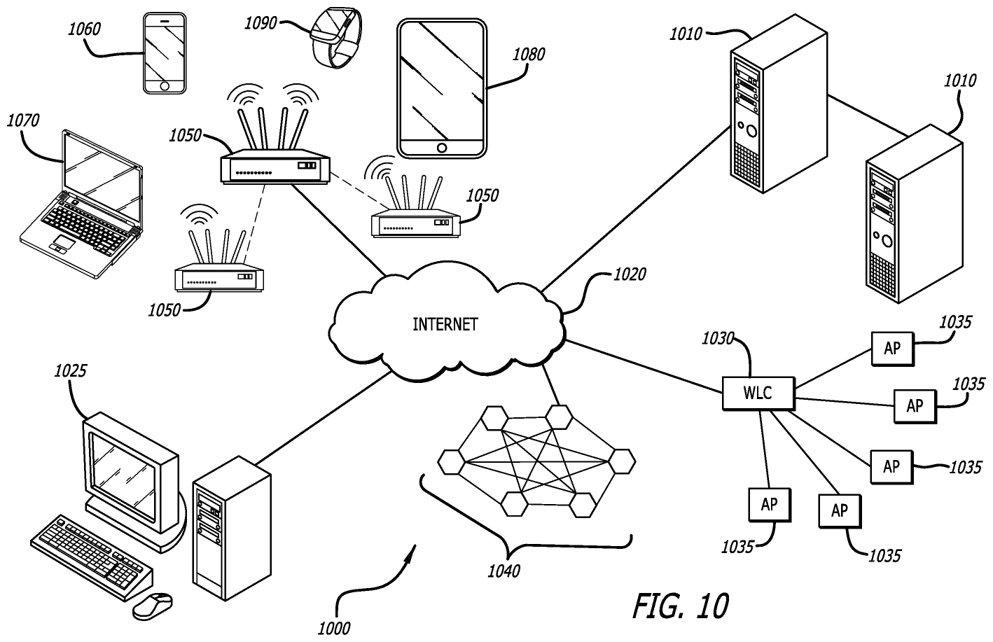

Referring to FIG. 10, a conceptual network diagram of various environments that an image to palette representation logic may operate within in accordance with various embodiments of the disclosure in accordance with various embodiments of the disclosure is shown. Those skilled in the art will recognize that an image to palette representation logic can be comprised of various hardware and/or software deployments and can be configured in a variety of ways. In some non-limiting examples, the image to palette representation logic can be configured as a standalone device, exist as a logic within another network device, be distributed among various network devices operating in tandem, or remotely operated as part of a cloud-based network management tool.

In many embodiments, the network 1000 may comprise a plurality of devices that are configured to transmit and receive data for a plurality of clients. In various embodiments, cloud-based centralized management servers 1010 are connected to a wide-area network such as, for example, the Internet 1020. In further embodiments, cloud-based centralized management servers 1010 can be configured with or otherwise operate an image to palette representation logic. The image to palette representation logic can be provided as a cloud-based service that can service remote networks, such as, but not limited to the deployed network 1040. In these embodiments, the image to palette representation logic can be a logic that receives data from the deployed network 1040 and generates predictions, receives environmental sensor signal data, and perhaps automates certain decisions or protective actions associated with the network devices. In certain embodiments, the image to palette representation logic can generate historical and/or algorithmic data in various embodiments and transmit that back to one or more network devices within the deployed network 1040.

However, in additional embodiments, the image to palette representation logic may be operated as distributed logic across multiple network devices. In the embodiment depicted in FIG. 10, a plurality of network access points (APs) 1050 can operate as an image to palette representation logic in a distributed manner or may have one specific device facilitate the detection of movement for the various APs. This can be done to provide sufficient needs to the network of APs such that, for example, a minimum bandwidth capacity may be available to various devices. These devices may include but are not limited to mobile computing devices including laptop computers 1070, cellular phones 1060, portable tablet computers 1080 and wearable computing devices 1090.

In still further embodiments, the image to palette representation logic may be integrated within another network device. In the embodiment depicted in FIG. 10, the wireless LAN controller 1030 may have an integrated image to palette representation logic that it can use to generate predictions, and perhaps detect anomalous movements regarding the various APs 1035 that it is connected to, either wired or wirelessly. In this way, the APs 1035 can be configured such that they can process image and/or palette related data. In still more embodiments, a personal computer 1025 may be utilized to access and/or manage various aspects of the image to palette representation logic, either remotely or within the network itself. In the embodiment depicted in FIG. 10, the personal computer 1025 communicates over the Internet 1020 and can access the image to palette representation logic within the cloud based centralized management servers 1010, the network APs 1050, or the WLC 1030 to modify or otherwise monitor the image to palette representation logic.

Although a specific embodiment for a conceptual network diagram of a various environments that an image to palette representation logic operating on a plurality of network devices suitable for carrying out the various steps, processes, methods, and operations described herein is discussed with respect to FIG. 10, any of a variety of systems and/or processes may be utilized in accordance with embodiments of the disclosure. For example, the image to palette representation logic may be implemented across a variety of the systems described herein such that some detections are generated on a first system type (e.g., remotely), while additional detection steps or protection actions are generated or determined in a second system type (e.g., locally). The elements depicted in FIG. 10 may also be interchangeable with other elements of FIGS. 1-9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each, and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
an image to palette representation logic configured to:
receive an image;
identify one or more objects in the image;
determine one or more colors for each identified object;
identify one or more areas of each identified object that comprise each color of the one or more colors;
calculate a set of overall areas comprising each of the one or more colors; and
generate a palette based on the calculated set of overall areas.

2. The device of claim 1, wherein the image to palette representation logic is configured to display the generated palette to a user.

3. The device of claim 1, wherein the image is received from a user.

4. The device of claim 1, wherein the image to palette representation logic is configured to:
access portions of a color spectrum, wherein the accessed portions include data of colors that are visible to human eye.

5. The device of claim 1, wherein the image to palette representation logic is configured to:
sort the calculated set of overall areas in a descending order, wherein a calculated overall area with a highest value is at first and a calculated overall area with a lowest value is at last; and
generate the palette based on a first predefined number of sorted overall areas.

6. The device of claim 1, wherein the image to palette representation logic is configured to:
for each of the one or more identified areas, generate a vector associated with each of the one or more colors, wherein a length of the vector is indicative of a cross-section of each of the identified one or more areas; and
calculate the set of overall areas comprising each of the one or more colors by adding lengths of the vectors associated with the each of the one or more colors.

7. The device of claim 1, wherein the image to palette representation logic is configured to:
calculate an overall vector associated with the image based on a vector summation of the overall areas;
calculate a vector summation for the generated palette; and
in response to a determination that a closeness ratio associated with the generated palette is larger than a predetermined threshold, store the palette, wherein the closeness ratio is defined as an inverse of a difference between the calculated vector summation of the palette and the calculated overall vector associated with the image.

8. The device of claim 7, wherein the image to palette representation logic is configured to display the palette to a user.

9. The device of claim 5, wherein a user selects the first predefined number of sorted overall areas.

10. The device of claim 1, wherein the image to palette representation logic includes one or more artificial intelligence models, and wherein the one or more artificial intelligence models include at least one of: a convolutional neural network, a region-based convolutional neural network, or a You Only Look Once neural network.

11. The device of claim 10, wherein the one or more artificial intelligence models are configured to at least: identify the one or more objects in the image, determine the one or more colors for each identified object, identify the one or more areas of each identified object, calculate the set of overall areas comprising each of the one or more colors, and generate the palette based on the calculated set of overall areas.

12. The device of claim 10, wherein the one or more artificial intelligence models are configured to at least: generate a vector associated with each of the one or more colors, calculate a vector summation for the generated palette, and determine whether or not a closeness ratio associated with the generated palette is larger than a predetermined threshold.

13. A method, comprising:
receiving an image;
identifying one or more objects in the image;
determining one or more colors for each identified object;
identifying one or more areas of each identified object that comprise each color of the one or more colors;
calculating a set of overall areas comprising each of the one or more colors; and
generating a palette based on the calculated set of overall areas.

14. The method of claim 13, further comprising:
sorting the calculated set of overall areas in a descending order, wherein a calculated overall area with a highest value is at first and a calculated overall area with a lowest value is at last; and
generating the palette based on a first predefined number of sorted overall areas.

15. The method of claim 13, further comprising:
for each of the one or more identified areas, generating a vector associated with each of the one or more colors, wherein a length of the vector is indicative of a cross-section of each of the identified one or more areas; and
calculating the set of overall areas comprising each of the one or more colors by adding lengths of the vectors associated with the each of the one or more colors.

16. The method of claim 13, further comprising:
calculating an overall vector associated with the image based on a vector summation of the overall areas;
calculating a vector summation for the generated palette; and
in response to a determination that a closeness ratio associated with the generated palette is larger than a predetermined threshold, storing the palette, wherein the closeness ratio is defined as an inverse of a difference between the calculated vector summation of the palette and the calculated overall vector associated with the image.

17. The method of claim 13, wherein the method further comprises displaying the generated palette to a user.

18. The method of claim 17, wherein the displaying is done on a graphical user interface.

19. The method of claim 13, wherein one or more artificial intelligence models are configured to perform at least: identifying the one or more objects in the image, determining the one or more colors for each identified object, identifying the one or more areas of each identified object, calculating the set of overall areas, generating the palette, generating a vector associated with each of the one or more colors, calculating the set of overall areas, calculating the overall vector, calculating a vector summation for the generated palette, and determining whether or not a closeness ratio associated with the generated palette is larger than a predetermined threshold.

20. An image to palette representation system, comprising:
one or more image to palette representation devices;
one or more processors coupled to the one or more image to palette representation devices; and
a non-transitory computer-readable storage medium for storing instructions that, when executed by the one or more processors, direct the one or more processors to:
receive an image;
identify one or more objects in the image;
determine one or more colors for each identified object;
identify one or more areas of each identified object that comprise each color of the one or more colors;
calculate a set of overall areas comprising each of the color for each color; and
generate a palette based on the calculated set of overall areas.
